(19) United States
(12) Patent Application Publication
(10) Pub. No.: US 2008/0137381 A1
(43) Pub. Date: Jun. 12, 2008

(54) Generation of auxiliary voltages in a ballast

(76) Inventor: Matthew Beasley, Dallas, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/638,164

(22) Filed: Dec. 12, 2006

(51) Int. Cl. H02M 3/335

(52) U.S. Cl. 363/21.02; 363/21.01

(57) ABSTRACT

An embodiment of the invention provides an apparatus for generating an auxiliary voltage in a ballast. The apparatus includes a transformer and a resonant circuit that is coupled to the input of the transformer. The apparatus also includes a first auxiliary circuit that is coupled to the auxiliary output of the transformer. The first auxiliary circuit is configured to generate a first output voltage V1. The apparatus also includes a second auxiliary circuit that is coupled to the resonant circuit and to the first auxiliary circuit. The second auxiliary output is configured to generate a second output voltage V2. At least one of the output voltages V1 and V2 provide an auxiliary output voltage Vaux of the transformer.

### BACKGROUND

A ballast is a device that provides a starting voltage and limits the amount of current flowing in an electric circuit. In some lamp ballasts applications, the low voltage output of a ballast is used to drive a discharge lamp at a main voltage output and is also used to control other electronic devices or cooling fans at an auxiliary voltage output. The discharge lamp is, for example, a lighting device that is used in a projector. To generate the auxiliary output voltage, an additional winding (inductor) is added next to the secondary winding of the transformer of the ballast. The auxiliary output voltage generated by this additional winding which, in turn, tracks the main output voltage which is generated by the secondary winding of the transformer.

The operating voltage of the discharge lamp at the output load of the ballast sets the value of the main output voltage of the secondary winding of the transformer. However, there is a wide ratio of the operating voltages between old and new discharge lamps, often around 2:1 (2-to-1). For example, an older discharge lamp may typically have an operating voltage of, for example, approximately 24 volts while a newer discharge lamp of the same type may have a reduced operating voltage of, for example, 12 volts. The above ratio in operating voltage is due to the electrode burn back that typically occurs as a lamp ages. This burn back or erosion of the electrodes increases the arc gap, resulting in a higher voltage that is required to maintain the arc. Since the auxiliary output voltage tracks the main output voltage which is set by the lamp operating voltage, the auxiliary output voltage can also vary by the same approximately 2:1 ratio of voltage swing, and as a result, the electronic devices that are driven by the auxiliary output voltage may not receive the required driving voltage if the voltage swing reaches a low voltage value.

In previous methods, a linear regulator or a switching regulator is coupled to the additional winding of the transformer so that the auxiliary output voltage is not subjected to the 2:1 ratio of voltage swing. The linear regulator subtracts a voltage from the auxiliary output voltage such that a constant output voltage may be maintained. The linear regulator is typically less expensive, but will typically have a considerable power loss due to the large voltage swing in the linear regulator resulting in a large voltage drop when the output voltage is high. A switching regulator will not have the considerable power loss of the linear regulator, but is more expensive and more complex in design. As a result, the regulators that drive the auxiliary output voltage have various disadvantages.

In other previous methods, an additional independent power supply is used to provide the auxiliary output voltage. However, this approach is also expensive due to the additional power requirement and additional components.

Therefore, the current technology is limited in its capabilities and suffers from at least the above constraints and deficiencies.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a circuit diagram of an apparatus in accordance with an embodiment of the invention.

FIG. 2 is a graph of example voltage values in an embodiment of the invention.

FIG. 3 is a graph of example voltage values in an embodiment of the invention.

FIG. 4 is a circuit diagram of an apparatus in accordance with another embodiment of the invention.

FIG. 5 is a graph of example voltage values in an embodiment of the invention.

FIG. 6 is a flow diagram of a method in accordance with an embodiment of the invention.

### DETAILED DESCRIPTION OF EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

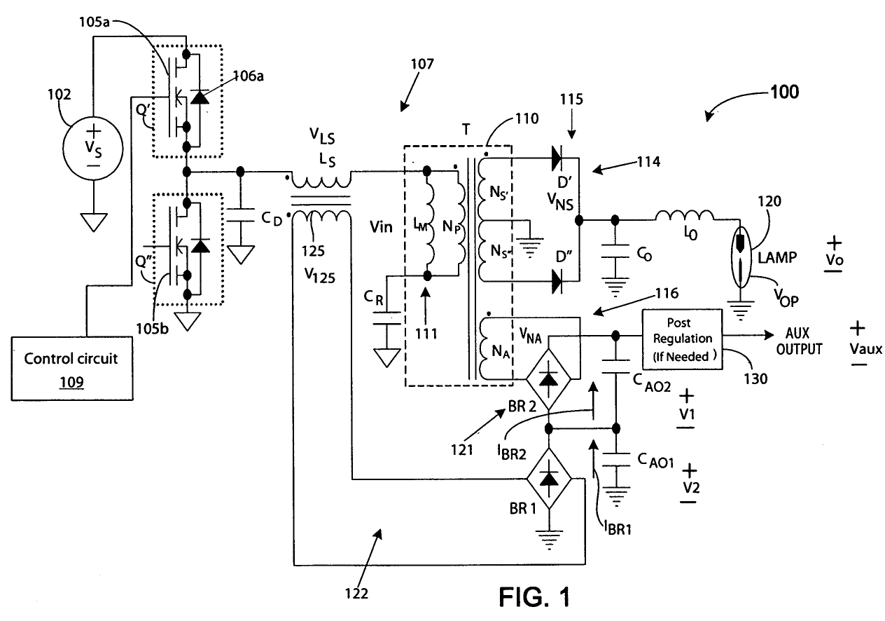

FIG. 1 is a block diagram of an apparatus 100 in accordance with an embodiment of the invention. A voltage source 102 provides a DC voltage (Vs) 102 that is input into the apparatus 100. The voltage source Vs (102) typically obtains the voltage from a power line or may be a portable power supply such as, for example, a battery. As known to those skilled in the art, when a power line provides the AC voltage to the voltage source Vs, then typically, the power line would be coupled to a conventional rectifier filter (not shown in FIG. 1) and the rectifier filter would, in turn, be coupled to the voltage source Vs.

Blocks Q′ and Q″ each forms a transistor switching stage. Typically, block Q′ is formed by a transistor 105a and an associated body diode 106a, and block Q″ is formed by a transistor 105b and an associated body diode 106b. The transistors 105a and 105b can be, for example, MOSFET transistors or other suitable transistor types. Typically, a conventional control circuit 109 controls the switching of the Blocks Q′ and Q″ so that the Blocks Q′ and Q″ are typically operated at approximately 50% duty cycle with a variable frequency which can be varied by adjusting the switching frequency of the transistors 105a and 105b. The value of the input voltage Vin into a transformer 110 is set by the switching frequency of the transistors 105a and 105b. Other known methods may also be used to generate the input voltage Vin for input into the transformer 110. The circuit configuration formed by voltage source Vs, blocks Q′ and Q″, and control circuit 109 in FIG. 1 is one known example of a circuit that controls the voltage that is driven into a transformer input.

The capacitor CD is a delay capacitor that prevents voltage loss when the transistors 105a and 105b are performing the switching of their frequency values.

A standard LLC (inductor-inductor-capacitor) resonant circuit 107 is formed by the inductor L_{S}, inductor L_{M}, and capacitor C_{R}. The L_{S} and L_{M} inductance values and C_{R} capacitance value are typically chosen so that a periodic electric oscillation of the currents driven into the transformer 110 can provide load matching into a load (lamp 120) over the lamp operating voltage range. The inductor L_{M} is coupled to the primary winding Np of the transformer 110. The capacitor C_{R} is a resonance capacitor. The LLC resonant circuit formed by L_{S}, L_{M}, and C_{R} minimizes power loss when the transistors 105a and 105b are switching.

The transform 110 is a standard step-down transformer. As a result, the transform 110 reduces the input voltage value Vin at the primary winding Np to a lower output voltage value V_{NS} that are output at a secondary winding Ns′ or secondary winding Ns″ at a time. The current though a secondary winding (Ns′ or Ns″) would be twice the current amount as opposed to when only one secondary winding is used. Each secondary winding is used half of the time as opposed to when there is only one secondary winding.

A standard center-tapped full-wave rectifier 115 is formed by the transformer 110, the diodes D′ and D″, and output capacitor Co. The output capacitor Co and output inductor Lo form a low pass filter that filters the output switching frequency of V_{NS}. This filtered output voltage Vo drives a load 120 such as, for example, a discharge lamp.

The value of the main output voltage Vo value at the transformer 110 load is set by the input voltage Vin of the transformer 110 and by the operating voltage (Vop) of the lamp load 120. Therefore, the main output voltage V_{NS} of the secondary windings (Ns′/Ns″) of the transformer 110 tracks the operating voltage (Vop) of the lamp load 120. As also mentioned above, the auxiliary output voltage V_{NA} (which generated by the additional winding N_{A}) tracks the main output voltage V_{NS} which, in turn, tracks the operating voltage (Vop) of the lamp load 120. The voltage of the output voltage Vo is set by the switching frequency in the transistors 105a and 105b. From the beginning to the end of a lamp's age, there could be a change in the operating voltage Vop of the lamp at, for example, approximately 2:1 ratio (e.g., from 24 volts to 12 volts).

As mentioned above, the auxiliary secondary winding output voltage V_{NA} tracks the main winding output voltage V_{NS} which, in turn, tracks the operating voltage Vop of the lamp 120. Discharge lamps typically have approximately 2:1 ratio in operating voltage Vop range over the life of the lamp 120. As a result, the rectified auxiliary winding output voltage V1 (which is voltage across the capacitor C_{AO2}) can vary over a 2:1 ratio in voltage range, if circuit 122 is not connected in the apparatus 100.

An auxiliary secondary winding output circuit 121 is formed by the auxiliary secondary winding NA, bridge rectifier BR2, and output capacitor C_{AO2}. Therefore, the circuit 121 is connected to the auxiliary output formed by the auxiliary winding NA of the transformer 110. The auxiliary secondary winding voltage V_{NA} is rectified by the bridge rectifier BR2 and filtered by the low pass filter capacitor C_{AO2} into the DC output voltage V1. The low pass filter capacitor C_{AO2} reduces the ripple in the auxiliary secondary winding voltage V_{NA}, since the discharge time of the capacitor C_{AO2} is much longer than the time between the recharging of the capacitor C_{AO2}. As known to those skilled in the art, ripple is the periodic variations in voltage from the steady DC value. Although bridge rectifiers are shown for BR1 and BR2, other suitable types of rectifiers may be used as well for BR1 and BR2.

In accordance with an embodiment of the invention, in order to compensate for the variation in the voltage range in the auxiliary winding output voltage V1, the auxiliary input circuit 122 is connected in series with the auxiliary winding output circuit 121. For purposes of brevity, the circuit 121 is also referred to as first auxiliary circuit 121 and circuit 122 is also referred to as second auxiliary circuit 122. The circuit 122 is connected to the input inductor L_{S} of the resonant circuit 107 at an input of the transformer 110. In the embodiment of FIG. 1, the bridge rectifier BR1 is connected to a secondary winding 125 and connected in series with the bridge rectifier BR2. Because of this series connection, the auxiliary output voltage Vaux (which drives a load at the auxiliary output) is the sum of V1 and V2 as shown in equation (1).

Vaux=V1+V2 (1)

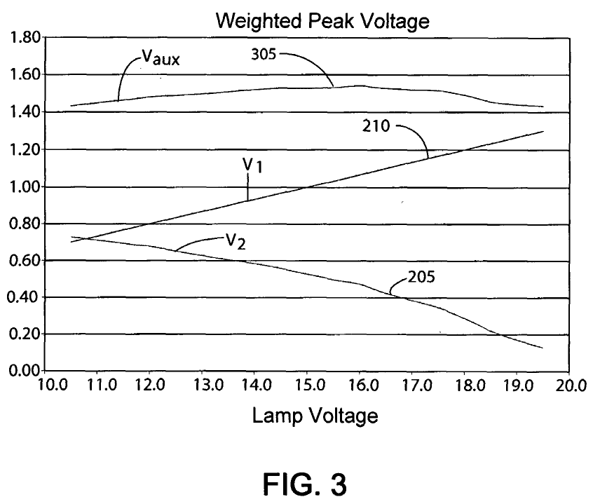

Any decrease in the V1 amount will be compensated by increase in the V2 voltage amount, so that the auxiliary output voltage Vaux does not vary over a 2:1 ratio voltage range. As shown in the example graph of FIG. 3 and discussed below, the circuit 122 permits the value of Vaux to remain substantially constant over a range of operating voltage Vop values for the lamp 120.

The circuit 122 includes a winding 125 that forms a secondary winding and the inductor L_{S} is a primary winding. At lower output voltages (Vo), more of the input source voltage 102 is dropped across inductor L_{S}. This results in a voltage (V₁₂₅) across secondary winding 125 that is increasing when the voltage (V_{NA}) on auxiliary winding NA is decreasing. The voltage (V₁₂₅) of the winding 125 is rectified by the bridge rectifier BR1 and filtered by the low pass filter C_{AO1} into the output voltage V2. Note that more of the input source voltage 102 is dropped across the inductor L_{S} when Vo is at lower levels, because the transformer 110 will also set Vin to a lower level in accordance with the transformer step down voltage ratio that is set by the transformer 110. As known to those skilled in the art, this transformer ratio is determined by the inductance values of the primary winding Np and secondary windings Ns/Ns″. The transformer 110 sets the ratio between the input voltage (primary winding voltage) Vin and secondary winding voltage V_{NS}. Therefore, if Vo is decreased (due to lower Vop values), then V_{NS} and Vin will also decrease, and more of the voltages from the voltage source 102 will be dropped across the inductor L_{S}. When Vo is increased (due to higher Vop values), then V_{NS} and Vin will also increase, and less of the voltages from the voltage source 102 will be dropped across the inductor L_{S}. When the voltage V_{LS} across L_{S} is increased or decreased, then the voltage V₁₂₅ across winding 125 is also increased or decreased, respectively.

The rectifier BR2 supplies the current I_{BR2} to the output capacitor C_{AO2} and the rectifier BR1 supplies the current I_{BR1} to the output capacitor C_{AO1}. A decrease or increase in V_{NA} respectively decreases or increases I_{BR2}. A decrease or increase in I_{BR2} respectively decreases or increases the voltage V1. A decrease or increase in V₁₂₅ respectively decreases or increases I_{BR1}. A decrease or increase in I_{BR1} respectively decreases or increases the voltage V2.

By selecting the ratio of voltages across the secondary winding 125 and the auxiliary winding NA on transformer 110 (i.e., ratio V₁₂₅/V_{NA}), the auxiliary voltage output Vaux does not vary over the 2:1 ratio as the operating voltage (Vop) of the lamp 120 varies over the 2:1 ratio during the lifetime of the lamp 120. The inductor values of windings L_{S}/125 and winding NA can be selected at various values in order to set the voltage ratio between voltages V₁₂₅ and V_{NA} (and therefore set a ratio between V2 and V1). Various known methods may be used to test and adjust the values of the ratio of V₁₂₅ and V_{NA} such as, for example, the use of computer simulation or standard circuit testing methods. As an example, the inductors of windings L_{S}/125 are scaled to approximately 49% of the auxiliary transformer winding NA. This 49% ratio would therefore be a ratio of the inductance values of windings L_{S}/125 and winding NA. With this 49% ratio, the auxiliary output Vaux typically varies by only approximately 8% over the operating voltage Vop range of the lamp 120. However, it is within the scope of an embodiment of the invention to set the ratio of the inductors of windings L_{S}/125 and NA to other ratio values, so that Vaux may vary above approximately 8% over the Vop range of the lamp 120 or so that Vaux may vary below approximately 8% over the Vop range of the lamp 120.

A post regulator 130 drives the auxiliary voltage output Vaux in the embodiment of FIG. 1. In another embodiment, the post regulator 130 is omitted and the Vaux voltage is generated without the use of the post regulator 130. If the voltage Vaux is driving, for example, a fan or other device types where an approximately 10% to 15% variation in the voltage Vaux does not affect the fan operation or other device operation, then the post regulator 130 can be omitted. If the voltage Vaux is driving an electronic device where a variation in Vaux may affect the electronic device operation, then the post regulator 130 may be used in the apparatus 100. Note also that the auxiliary circuits 121 and 122 provide improved voltage regulation which, in turn, allows for a more power efficient linear regulator circuit 130. Since the change in the range of the combined voltage output V1 and V2 of the auxiliary circuits 121 and 122 is more tightly controlled, the voltage input into the linear regulator 130 can be set to lower values in the worst case scenario (i.e., when V1 decreases to a minimum value). As a result, since the linear regulator 130 requires less voltage input in this worst case scenario due to the voltage V2 being provided for Vaux, less power is wasted over the life of the lamp 120.

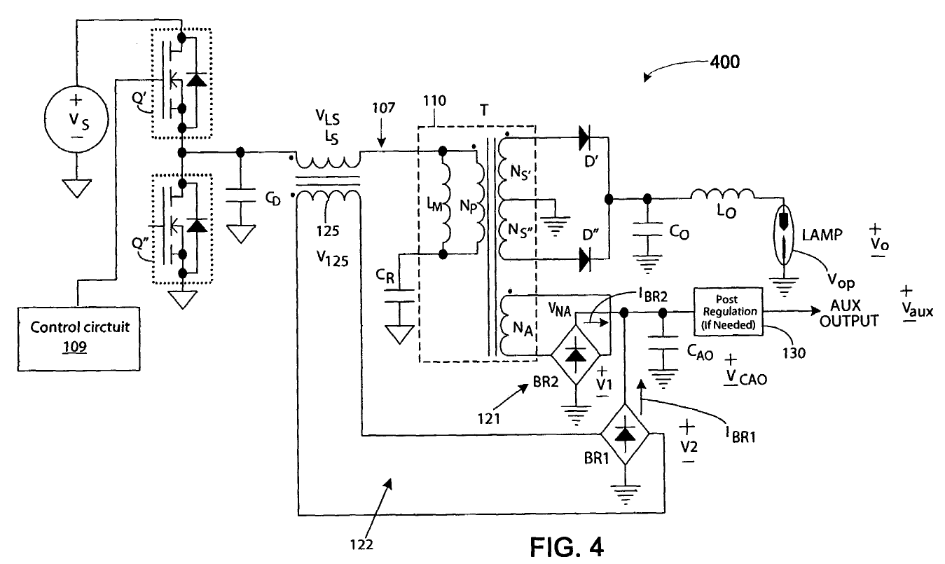

Another embodiment of the invention also provides a method for assembling an apparatus 100 or apparatus 400 (FIG. 4) for generating an auxiliary voltage in a ballast. A transformer 110 is provided, and the transformer 110 includes an input 111, an output 114, and an auxiliary output 116. The resonant circuit 107 is connected to the input 111 of the transformer 110. The first auxiliary circuit 121 is connected to the auxiliary output 116 of the transformer 110. The second auxiliary circuit 122 is connected to the resonant circuit 107 and to the first auxiliary circuit 121. The first and second auxiliary circuits 121 and 122 may be connected in series (see FIG. 1) or in parallel (see FIG. 4). The voltage source 102, switching stages Q′ and Q″ and capacitor Co are connected to the resonant circuit 107. The particular order of connecting the above components may vary in sequence or order.

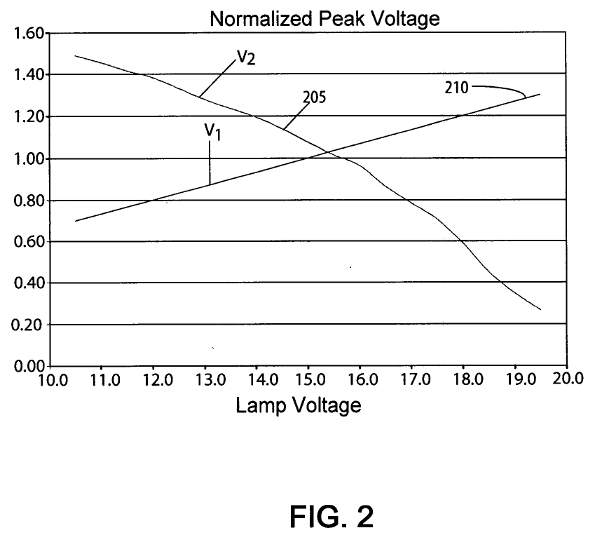

FIG. 2 is a graph illustrating example voltage levels in an embodiment of the invention. The Y axis represents the normalized voltage values V2 on the auxiliary circuit 122 of FIG. 1. In the example of FIG. 2, the values of V2 are normalized by approximately 15 volts (i.e., 1.00 is the normalized value of 15 volts and 0.50 is the normalized value of 7.5 volts). The X axis represents the operating voltage values Vo of the lamp 120.

The line 205 represents the V2 output voltage from the auxiliary circuit 122 and the line 210 represents the output voltage V1 (see FIG. 1) from auxiliary circuit 121 (which includes the auxiliary winding NA). The voltage values represented by the lines 205 and 210 are normalized to 1 volt at the middle value of the lamp voltage range. These voltage values have been normalized because any practical voltage values can be produce by adjusting the ratio of the voltage (V₁₂₅) across winding 125 and voltage (V_{NA}) across winding NA.

In FIG. 2, the line 210 of voltage V1 (of auxiliary transformer winding circuit 121) tracks the lamp voltage at Vop (FIG. 1) linearly. Therefore, as voltage Vop increases over the lifetime of the lamp 120, voltage V1 also increases linearly as Vop increases. The voltage V2 of circuit 122 varies roughly inversely from voltage V1. Therefore, as voltage V1 increases, the voltage V2 decreases, and vice versa, as shown in the FIG. 2 graph. As previously mentioned above, for lower Vop values, more of the input source voltage 102 is dropped across inductor L_{S}, and as a result, V₁₂₅ will have increased values which, in turn, increases V2. Note that line 205 is typically non-linear because of the resonant circuit's 107 design and electrical characteristics.

FIG. 3 is a graph illustrating examples of the rectified output voltages V1 and V2 from the winding NA and winding 125, respectively. As an example, the inductors of windings L_{S}/125 are scaled to approximately 49% of the auxiliary transformer winding NA. With this 49% ratio, the auxiliary output Vaux typically varies by only, for example, approximately 8% over the operating voltage range of the lamp 120. In many applications, particularly where Vaux provides power for particular auxiliary loads such as, for example, cooling devices of the ballast and/or lamp, this 8% variation is acceptable and an additional post regulator 130 at auxiliary voltage output Vaux is typically not required to be used to drive the auxiliary load.

The line 305 in FIG. 3 shows the summed value of V1 (line 210) and V2 (line 205), in one example. This summed value is the auxiliary output voltage Vaux over a range of lamp operating voltages. The voltage Vaux is nearly constant as shown by the line shape of 305 which has a minimized curvature.

FIG. 4 is a block diagram of an apparatus 400 in accordance with another embodiment of the invention. The circuits 121 and 122 are connected in parallel since the bridge rectifiers BR2 and BR1 are connected in parallel. Therefore, the Vaux output (which is the capacitor voltage V_{CAO} across output capacitor C_{AO}) is generated by whichever of the winding NA or winding 125 that is producing the higher voltage value. For example, if the output voltage V2 from the second auxiliary circuit 122 is higher than the output voltage V1 from the first auxiliary circuit 121, then Vaux will be at the V2 value. If the output voltage V1 from the circuit 121 is higher than the output voltage V2 from the circuit 122, then Vaux will be at the V1 value.

The switching between V1 and V2 for the Vaux value is performed by the rectifiers BR1 and BR2. When the voltage (V_{NA}) across winding NA is higher than the voltage (V₁₂₅) across the winding 125, the voltage across the rectifier BR2 is higher than the voltage across the rectifier BR1. As a result, the rectifier BR2 supplies the current I_{BR2} to the output capacitor CAO and the voltage across capacitor C_{AO} will therefore be the rectified voltage V1 from the voltage V_{NA} of winding NA.

When the voltage (V₁₂₅) across winding 125 is higher than the voltage across the winding NA, the voltage across the rectifier BR1 is higher than the voltage across the rectifier BR2. As a result, the rectifier BR1 supplies the current I_{BR1} to the output capacitor C_{AO} and the voltage across capacitor C_{AO} will therefore be the rectified voltage V2 from voltage (V1₂₅) of winding 125.

Therefore, Vaux can be represented by equation (2).

Vaux=V_{CAO}=V1 if V1>V2, and (2)

Vaux=V_{CAO}=V2 if V2>V1

Alternatively, equation (2) can be modified so that Vaux=V1 if V1>V2, and Vaux=V2 if V2>V1.

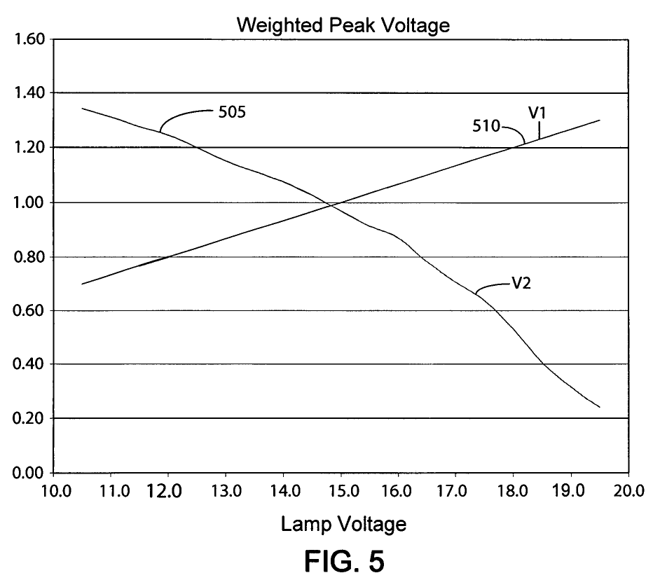

FIG. 5 is a graph of example voltages produced by the rectified outputs V1 and V2 from the apparatus 400 in FIG. 4. Line 505 is the rectified voltage V2 from the winding 125, and line 510 is the rectified voltage V1 from the winding NA. The Vaux output varies by approximately 30% over the operating voltage Vop range of the lamp 120 in the example of FIG. 5, and as a result, the apparatus 400 in FIG. 4 also achieves improved results as compared to conventional approaches.

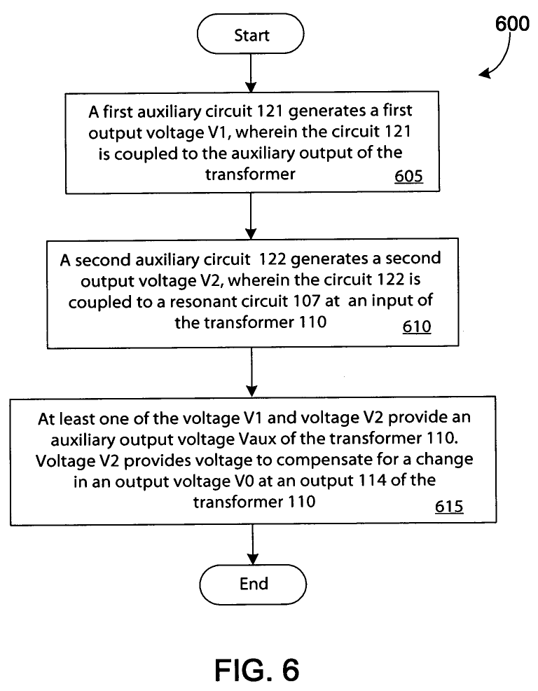

FIG. 6 is a flow diagram of a method 600 of generating an auxiliary voltage (Vaux) in a ballast, in accordance with an embodiment of the invention. In block 605, a first auxiliary circuit 121 generates a first output voltage V1, wherein the circuit 121 is coupled to the auxiliary output 116 of the transformer 110. In block 610, a second auxiliary circuit 122 generates a second output voltage V2, wherein the circuit 122 is coupled to the resonant circuit 107 at the input 111 of the transformer 110. The circuits 121 and 122 may be connected in series or in parallel. The steps in blocks 605 and 610 typically occur concurrently. In block 615, at least one of the output voltages V1 and V2 provide an auxiliary output voltage Vaux of the transformer 110. Voltage V2 provides voltages to compensate for a change in an output voltage Vo at an output 114 of the transform 110. A change in Vo can occur if, for example, the operating voltage Vop of a load 120 changes over time.

Embodiments of this invention can provide an improved method for generation of auxiliary voltages in LLC resonant converter ballasts. Embodiments of the invention can permit reduced components costs and can improve reliability of lamp ballast in generating the auxiliary output voltage. Additionally, in an embodiment of the invention, the ballast can generate the auxiliary voltage output without the requirement of a separate power supply, and therefore lower system cost can be achieved.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus for generating an auxiliary voltage in a ballast, the apparatus comprising:
a transformer including an input, an output, and an auxiliary output;
a resonant circuit coupled to the input of the transformer;
a first auxiliary circuit coupled to the auxiliary output of the transformer and configured to generate a first output voltage V1; and
a second auxiliary circuit coupled to the resonant circuit and to the first auxiliary circuit, and configured to generate a second output voltage V2;
wherein at least one of the the output voltages V1 and V2 provide an auxiliary output voltage Vaux of the transformer.

2. The apparatus of claim 1, wherein the output voltage V2 provides voltage to compensate for a change in an output voltage Vo at the output of the transformer.

3. The apparatus of claim 1, wherein the first auxiliary circuit and second auxiliary circuit are connected in series.

4. The apparatus of claim 1, wherein the first auxiliary circuit and second auxiliary circuit are connected in parallel.

5. The apparatus of claim 1, wherein the first auxiliary circuit comprises a first rectifier and an auxiliary winding of the transformer; and
wherein the second auxiliary circuit comprises a second rectifier and a secondary winding in the resonant circuit.

6. The apparatus of claim 5, wherein a ratio is set for inductance values between the secondary winding in the resonant circuit and the auxiliary winding of the transformer, in order to set a voltage ratio between V2 and V1.

7. The apparatus of claim 1, wherein the second auxiliary circuit increases the second output voltage V2 if the first output voltage V1 decreases; and
wherein the second auxiliary circuit decreases the second output voltage V2 if the first output voltage V1 increases.

8. The apparatus of claim 1, wherein the first auxiliary circuit generates the first output voltage V1 as the auxiliary output voltage Vaux, if V1 is greater than V2; and
wherein the second auxiliary circuit generates the second output voltage V2 as the auxiliary output voltage Vaux, if V2 is greater than V1.

9. The apparatus of claim 1, wherein the voltage V1 tracks an output voltage Vo of the transformer.

10. A method for generating an auxiliary voltage in a ballast, the method comprising:
generating, by a first auxiliary circuit, a first output voltage V1, wherein the first auxiliary circuit is coupled to an auxiliary output of a transformer; and
generating, by a second auxiliary circuit, a second output voltage V2, wherein the second auxiliary circuit is coupled to a resonant circuit at an input of the transformer;
wherein at least one of the output voltages V1 and V2 provide an auxiliary output voltage Vaux of a transformer.

11. The method of claim 10, wherein the output voltage V2 provides voltage to compensate for a change in an output voltage Vo at an output of the transformer.

12. The method of claim 10, wherein the first auxiliary circuit and second auxiliary circuit are connected in series.

13. The method of claim 10, wherein the first auxiliary circuit and second auxiliary circuit are connected in parallel.

14. The method of claim 10, further comprising:
setting a ratio for inductance values between the secondary winding in the resonant circuit and the auxiliary winding of the transformer, in order to set a voltage ratio between V2 and V1.

15. The method of claim 10, further comprising:
increasing the second output voltage V2 if the first output voltage V1 decreases; and
decreasing the second output voltage V2 if the first output voltage V1 increases.

16. The method of claim 10, further comprising:
generating the first output voltage V1 as the auxiliary output voltage Vaux, if V1 is greater than V2; and
generating the second output voltage V2 as the auxiliary output voltage Vaux, if V2 is greater than V1.

17. The method of claim 10, wherein the voltage V1 tracks an output voltage Vo of the transformer.

18. A method for assembling an apparatus for generating an auxiliary voltage in a ballast, the method comprising:
providing a transformer including an input, an output, and an auxiliary output;
connecting a resonant circuit to the input of the transformer;
connecting a first auxiliary circuit to the auxiliary output of the transformer; and
connecting a second auxiliary circuit to the resonant circuit and to the first auxiliary circuit.

19. The method of claim 18, further comprising: connecting the first auxiliary circuit and second auxiliary circuit in series.

20. The method of claim 18, further comprising: connecting the first auxiliary circuit and second auxiliary circuit in parallel.

21. The method of claim 18, wherein the first auxiliary circuit comprises a first rectifier and an auxiliary winding of the transformer; and
wherein the second auxiliary circuit comprises a second rectifier and a secondary winding in the resonant circuit.
